(19) United States
(12) Patent Application Publication
(10) Pub. No.: US 2008/0203872 A1
(43) Pub. Date: Aug. 28, 2008

(54) Stand for home appliance

(76) Inventor: Han Ki Cho, Changwon-si (KR)

Correspondence Address: MCKENNA LONG & ALDRIDGE LLP, 1900 K STREET, NW, WASHINGTON, DC, 20006, US

(21) Appl. No.: 12/149,253

(22) Filed: Apr. 29, 2008

Related U.S. Application Data
(62) Division of application No. 10/875,313, filed on Jun. 25, 2004.

(30) Foreign Application Priority Data
Jul. 8, 2003 (KR) P2003-0046032
Jun. 28, 2004 (KR) P2003-0042956

(51) Int. Cl. A47B 88/00; E05B 65/46; F16M 11/24

(52) U.S. Cl. 312/330.1; 312/217; 248/188.2

(57) ABSTRACT

Stand including a stand body of a predetermined height having an opening in one side, a drawer for pushing in or pulling out through the opening in the stand body to open/close the opening, a guide device for smooth pushing in/pulling out of the drawer, and a self locking device for automatic locking of the drawer when the drawer is inserted in the stand more than a certain depth, and preventing slipping out of the drawer even if the stand is tilted.

This application claims the benefit of the Korean Application Nos. P2003-0042956 filed on Jun. 28, 2003, and P2003-0046032 filed on Jul. 8, 2003, which are hereby incorporated by reference.

### BACKGROUND OF THE INVENTION

1. Field of the Invention

The present invention relates to stands for supporting objects at a required height, and more particularly, to a stand for a home appliance in which things can be kept.

2. Background of the Related Art

In general, a drum type washing machine washes laundry by using friction between a drum rotated by a motor and the laundry, and chemical action of detergent in a state the detergent, washing water, and the laundry are introduced into the drum, shows no entangling of the laundry, and has a washing effect of pounding and rubbing the laundry.

The drum type washing machine is provided with a cabinet having an opening in a front for introduction/taking out the laundry. The cabinet, substantially hexahedral, forms an exterior of the drum type washing machine, and has a control panel, and a door for opening/closing the opening for introduction/taking out the laundry therethrough on the front.

Meanwhile, since opening for introduction/taking out the laundry of the drum washing machine is positioned low, the user is required to bend for introduction or taking out the laundry of the drum type washing machine. For eliminating the inconvenience of bending, a stand for the washing machine is developed for supporting the drum type washing machine at a predetermined height.

FIG. 1 illustrates a perspective view of a related art drum type washing machine, and a related art washing machine stand under the drum type washing machine for supporting the drum type washing machine at a predetermined height, schematically.

Referring to FIG. 1, the related art washing machine stand 20 is provided with a front panel, side panels connected to opposite edges of the front panel at right angles, and a rear panel having opposite edges connected to rear edges of the side panels, respectively.

A horizontal area of the washing machine stand is similar to a bottom area of the drum type washing machine, and has a supporting plate 21 at a top of each corner where adjacent panels are connected to each other, for placing a leg 11 of the drum type washing machine. There is a stand leg 22 on an underside of the stand 20, in more detail, on a bottom of each corner where adjacent panels are connected to each other, having a height adjustable bolt structure.

However, the related art washing machine stand has the following problems.

First, the related art washing machine stand simply supports the underside of the drum type washing machine at a predetermined height, but fails to use an inside space thereof.

Second, for supporting a drum type washing machine or a laundry dryer having different positions of legs, the related art washing machine stand is required to have different positions of the supporting plates for seating the legs.

Third, since the supporting plate of the related art washing machine just seats, but not holds the leg of the drum type washing machine, the leg of the drum type washing machine is liable to come off the supporting plate from vibration occurred during operation of the drum type washing machine.

### SUMMARY OF THE INVENTION

Accordingly, the present invention is directed to a stand for a home appliance that substantially obviates one or more of the problems due to limitations and disadvantages of the related art.

An object of the present invention is to provide a stand for supporting an object at a height, and having a drawer for using an inside space.

Other object of the present invention is to provide a stand which can be used in supporting one of objects with different leg positions, such as a drum type washing machine, or a laundry dryer.

Another object of the present invention is to provide a stand which automatically locks a drawer if the drawer is inserted more than a depth into an inside of the stand, and prevents slipping out of the drawer even if the stand is tilted.

Additional features and advantages of the invention will be set forth in the description which follows, and in part will be apparent to those having ordinary skill in the art upon examination of the following or may be learned from practice of the invention. The objectives and other advantages of the invention will be realized and attained by the structure particularly pointed out in the written description and claims hereof as well as the appended drawings.

To achieve these objects and other advantages and in accordance with the purpose of the present invention, as embodied and broadly described herein, the stand includes a stand body of a predetermined height having an opening in one side, and a drawer for pushing in or pulling out through the opening in the stand body to open/close the opening.

The drawer includes a drawer body having a receiving space formed therein, a front cover that is a front of the drawer body for covering the opening of the stand body when the drawer body is pushed in, and a handle provided to the front cover.

The front cover has a recess form in rear of the handle at a predetermined depth.

The handle includes a front part that is a front of the handle, and a rear part in rear of the front part.

The handle is fastened to the front cover with fastening projections each having an axial direction hole with a thread formed therein projected from a rear surface of the handle to backward, and pass through hole passed through a front and a rear surfaces of the front cover to insert the fastening projections therein, and fasten.

The handle includes one pair of seating parts projected backward from opposite sides of an upper surface thereof, and the front cover includes one pair of seating recesses in opposite sides of an upper surface of the front cover for seating the one pair of seating parts.

The handle includes a fixing projection of a predetermined size projected backward from each of the seating parts, and the front cover includes a fixing hole in a rear wall of each of the seating recesses of the front cover for inserting the fixing projection.

The stand further includes a guide device for guiding the drawer to push in or pull out the drawer smoothly.

The guide device includes a supporting guide mounted on opposite inside surfaces of the stand body in a pulling out/pushing in direction of the drawer, a pulling out/pushing in guide mounted on opposite outside walls of the drawer body in the pulling out/pushing in direction of the drawer, and rolling means for minimizing friction between the supporting guide and the pulling out/pushing guide, to make the pulling out/pushing of the drawer smooth.

The supporting guide has a bar form, and the pulling out/pushing in guide has a groove for inserting the supporting guide.

The pulling out/pushing in guide has a bar form, and the supporting guide has a groove for inserting pulling out/pushing in guide.

The rolling means includes rolling members between the supporting guide and the pulling out/pushing in guide, and a rolling member supporting part for rotatably supporting the rolling members. The rolling member includes a ball or a roller.

The rolling member supporting part is fixed to the pulling out/pushing in guide.

The stand further includes a self locking device for automatic closure and holding the drawer if the drawer is pushed in the stand body more than a certain depth, and maintaining a holding state of the drawer unless an external force higher a certain level is not applied thereto.

The self locking device includes a holding member fitted to the supporting guide, and a hook assembly fitted to the pulling out/pushing in guide for engagement with the holding member if the drawer is pushed in the stand body more than a certain depth, to close the drawer automatically, and disengagement from the holding member to open the drawer smoothly if the drawer is pulled out with an external force higher than a certain level applied for pulling out the drawer.

The holding member is fitted to a rear portion of the supporting guide, and the hook assembly is fitted to a rear portion of the pulling out/pushing in guide to align with the holding member when the drawer is closed fully.

The hook assembly includes a hook part for engagement with the holding member when the drawer is pushed in the stand body more than a certain depth, and disengagement from the holding member when an external force higher than a certain level is applied thereto for pulling out the drawer, a hook guide part for guiding movement of the hook part in a state the hook part is engaged with the holding member, and guiding the hook part to disengage from the holding member when the drawer is pulled out more than a certain distance, and an elastic part connected between the hook part and the hook guide part, for applying a restoring force to the hook part to close the drawer automatically if the hook part is engaged with the holding member following pushing in of the drawer in the stand body to make the hook part to engage with the holding member.

The hook guide part includes a first guide slot extended in the pulling out/pushing in direction of the drawer, a second guide slot parallel to the first guide slot, having a rear end extended more than a predetermined length longer than the rear end of the first guide slot, and a third guide slot vertically extended from the rear end of the second guide slot toward the first guide slot, and the hook part includes a first pin movable along the first guide slot, and a second pin movable along the second guide slot or the third guide slot.

The hook guide part further includes a projection from an inside corner where the second guide slot and the third guide slot meet, for engagement of the hook part therewith when the drawer is pulled out more than a certain distance to disengage the hook part from the holding member.

The elastic part is a spring having one end connected to a first pin of the hook part, and the other end connected to a front end of the first guide slot.

The stand body includes leg seating members at respective corners of an upper surface thereof for seating legs of an object to be supported by the stand body.

The stand body is applicable to other object with legs having distances of legs shorter than the object.

The leg seating member includes a first seating hole for seating a leg of a washing machine, and a second seating hole for seating a leg of a laundry dryer having legs with distances shorter than distances of the legs of the washing machine.

The second seating hole is overlapped with a part of the first seating hole or spaced a distance apart therefrom.

The stand body includes height adjustable leg assemblies each is provided to an underside surface of the stand body.

The leg assembly includes a leg bolt having a screw part with a thread on an outside circumferential surface for fastening to a lower part of the stand body, and a bolt head at a lower end of the screw part, a damping member of a soft material having an upper surface in close contact with the bolt head and a lower surface in contact with a floor where the stand stands thereon, and a holder for holding the damping member and the bolt head together.

The bolt head includes a polygonal upper head part formed as one unit with, and at a lower end of, the screw part, and a circular lower head part formed as one unit with, and under, the upper head part.

The damping member is fastened to the lower head part for preventing relative rotation with respect to the leg bolt.

The holder is substantially annular with passed through top and bottom, for pressing an upper surface of an edge of the lower head part and an underside surface of an edge of the damping member from an upper side and a lower side respectively, and holding the lower head part and the damping member together, when the lower part of the damping member is projected downward through the passed through lower part.

The holder includes an annular holder body with passed through top and bottom for holding outside circumferences of the lower head part and the damping member, a lower holding part having an outside circumferential surface connected to an inside circumferential surface of a bottom end of the holder body, to support an underside surface of the damping member, and an opening in a central part for pass through of the lower part of the damping member, and an upper holding part projected from an upper inside circumferential surface of the holder body toward a center, for holding an upper surface of an edge of the lower head part, having a distance from an upper surface of the lower holding part to an underside surface smaller than a sum of a thickness of the edge of the damping member and a thickness of the edge of the lower head part.

The upper holding part includes a plurality of hooks at regular intervals in a circumferential direction.

The lower holding part includes a plurality of cut away openings under the hooks respectively.

The holder and the leg bolt are formed not to make relative rotation.

The holder includes holder rotation prevention projections in an inside surface thereof, and the bolt head includes holder rotation prevention grooves on an outside surface thereof for inserting the holder rotation prevention projections therein.

The holder is formed of non-soft material, and has a polygonal outside circumferential surface.

The stand body includes reinforcing members at opposite sides of the opening for supporting a load of the object supported by the stand body.

It is to be understood that both the foregoing description and the following detailed description of the present invention are exemplary and explanatory and are intended to provide further explanation of the invention claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

In the drawings;

FIG. 1 illustrates a perspective view of a related art drum type washing machine, and a related art washing machine stand;

FIG. 2 illustrates a perspective view of a related art drum type washing machine, and a washing machine stand in accordance with a preferred embodiment of the present invention;

FIG. 3 illustrates a perspective view of an upper part of a washing machine stand in accordance with a preferred embodiment of the present invention;

FIG. 4 illustrates a perspective view of a stand body of a washing machine stand in accordance with a preferred embodiment of the present invention, with a partial cut away view;

FIG. 5 illustrates a front view of a leg assembly of a washing machine stand in accordance with a preferred embodiment of the present invention, with a partial cut away view;

FIG. 6 illustrates a bottom view of a leg assembly of a washing machine stand in accordance with a preferred embodiment of the present invention;

FIG. 7 illustrates a front disassembled view of a leg assembly of a washing machine stand in accordance with a preferred embodiment of the present invention, with a partial cut away view;

FIG. 8 illustrates a perspective view of a drawer of a washing machine stand in accordance with a preferred embodiment of the present invention;

FIG. 9 illustrates a disassembled perspective view of the drawer in FIG. 8;

FIG. 10 illustrates a partial enlarged perspective view of “A” part in FIG. 9;

FIG. 11 illustrates a diagram of a guide device and a self locking device for pulling out/pushing in a drawer of a washing machine stand in accordance with a preferred embodiment of the present invention;

FIG. 12 illustrates an enlarged view of “B” part in FIG. 11;

FIG. 13 illustrates a section across a line I-I in FIG. 12;

FIG. 14A illustrates an enlarged view of “C” part in FIG. 11 showing a self locking device in a state a drawer is pushed in fully;

FIG. 14B illustrates an enlarged view of “C” part in FIG. 11 showing a self locking device in a state a drawer starts to be pulled out;

FIG. 14C illustrates an enlarged view of “C” part in FIG. 11 showing a self locking device in a state locking of a drawer is released.

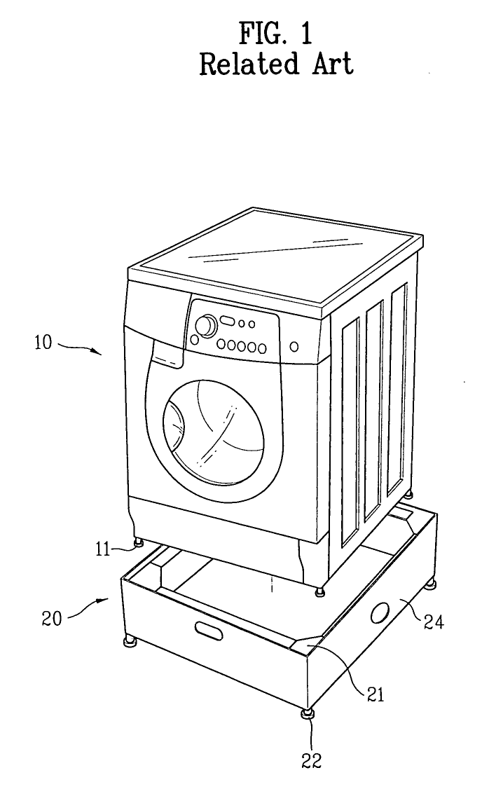

### DETAILED DESCRIPTION OF THE PREFERRED EMBODIMENT

Reference will now be made in detail to the preferred embodiments of the present invention, examples of which are illustrated in the accompanying drawings. In describing the embodiments, identical parts will be given the same names and reference symbols, and repetitive description of which will be omitted.

As one example of stand of the present invention, a washing machine stand will be described among stands for supporting home appliances, such as a drum type washing machine.

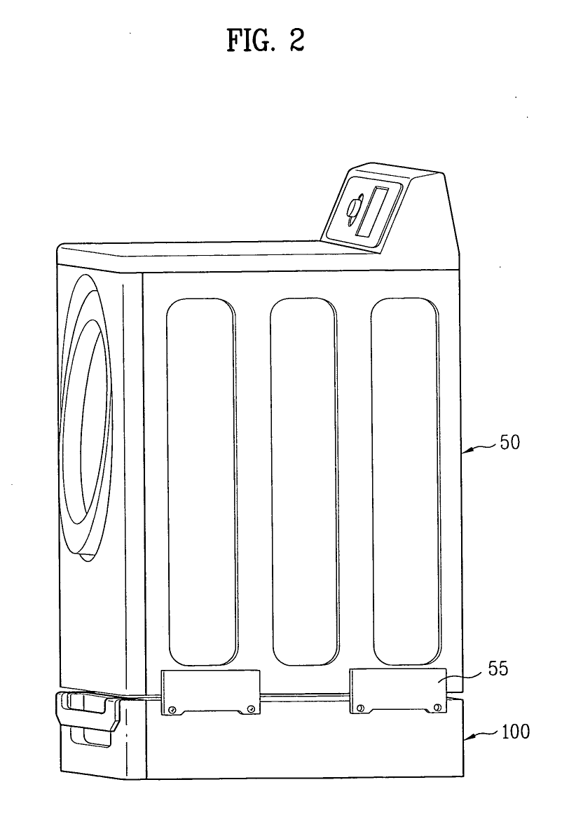

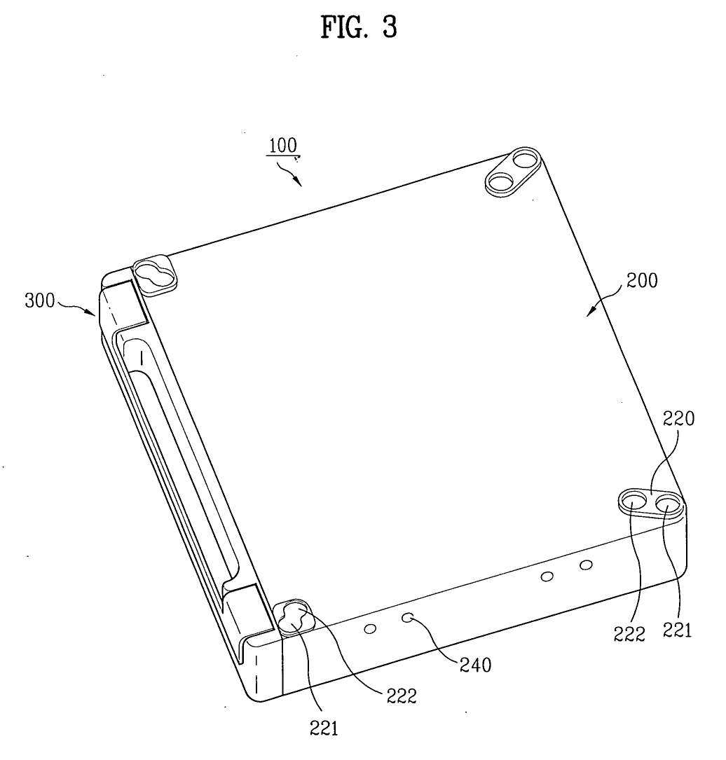

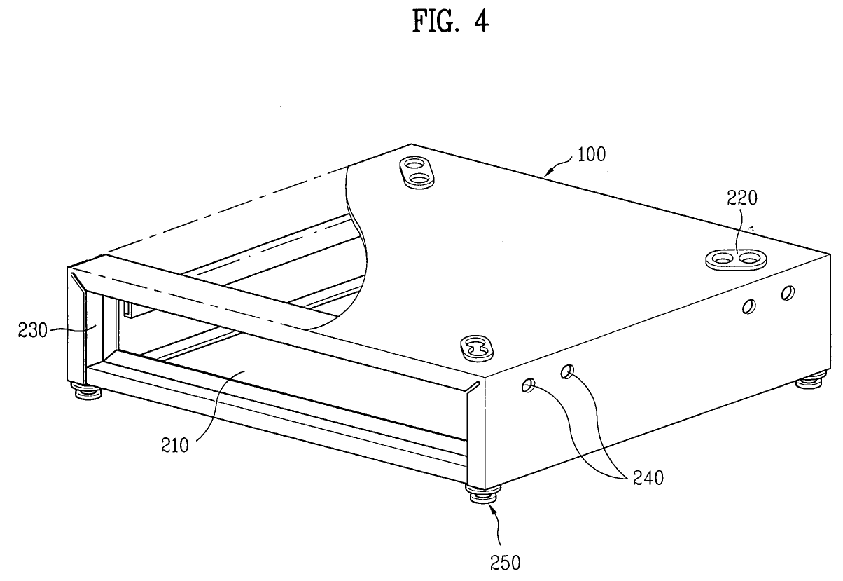

Referring to FIGS. 2˜4, the washing machine stand 100 includes a hexahedral stand body 200 having an opening 210 in a front, and a drawer 300 for pulling/pushing out/in the stand body 200 through the opening 210.

There is a leg seating member 220 on a top of each corner of the stand body 100 having a first seating hole 221 for seating one of legs (not shown) of a drum type washing machine 50 thereon.

However, the washing machine stand 100 has a system for seating, not only the drum type washing machine, but also a laundry dryer (not shown) thereon. For this, the leg seating member 220 has a second seating hole 222 at a position corresponding to a leg position of the laundry dryer. The second seating hole 222 may overlap with the first seating hole 221 partly, or spaced away therefrom. In general, since a distance between legs of the laundry dryer is smaller than a distance between legs of the drum type washing machine, the second seating holes 222 are formed on inner sides of the first seating holes 221 in a diagonal direction of the top of the stand body.

For seating the drum type washing machine or the laundry dryer, seating recesses (not shown) may be formed in the top of the stand body 200 at positions in correspondence to the positions of the legs as one unit with the stand body 200 without using the leg seating members.

In addition to this, it is preferable that reinforcing members 230 are fitted to opposite sides of the opening 210 of the stand body 200 for sustaining a load of the drum type washing machine 50 or the laundry dryer to be seated on the stand body 200.

There are fastening holes 240 in opposite sides of the stand body 200 for fastening binding members 51 thereto respectively, for fastening the drum type washing machine or the laundry dryer to the stand body 200.

In the meantime, there is a height adjustable leg assembly 250 at each of underside corners of the stand body 200, for supporting the stand body 200.

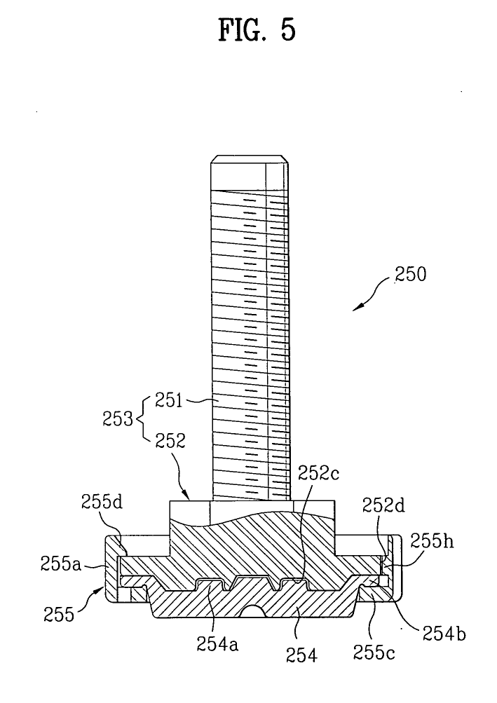

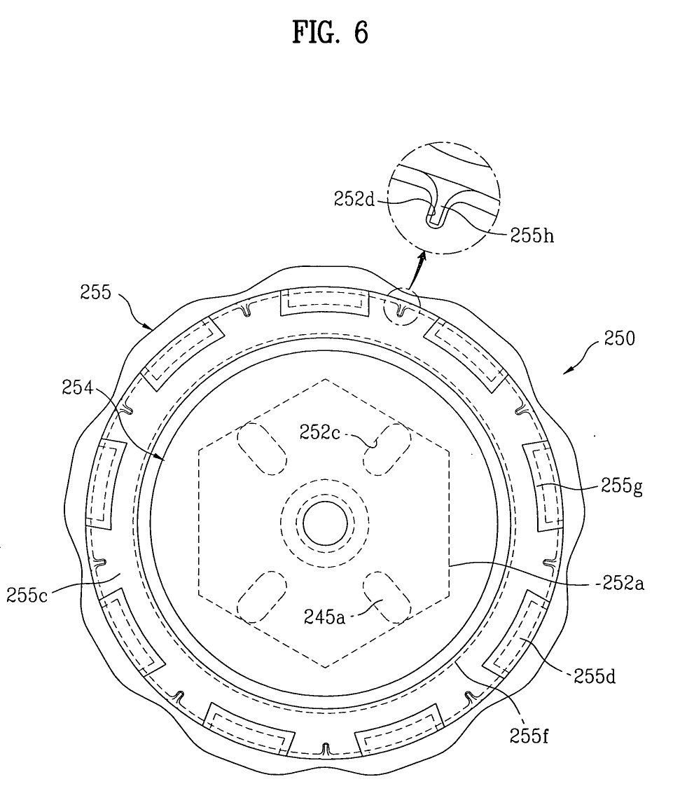

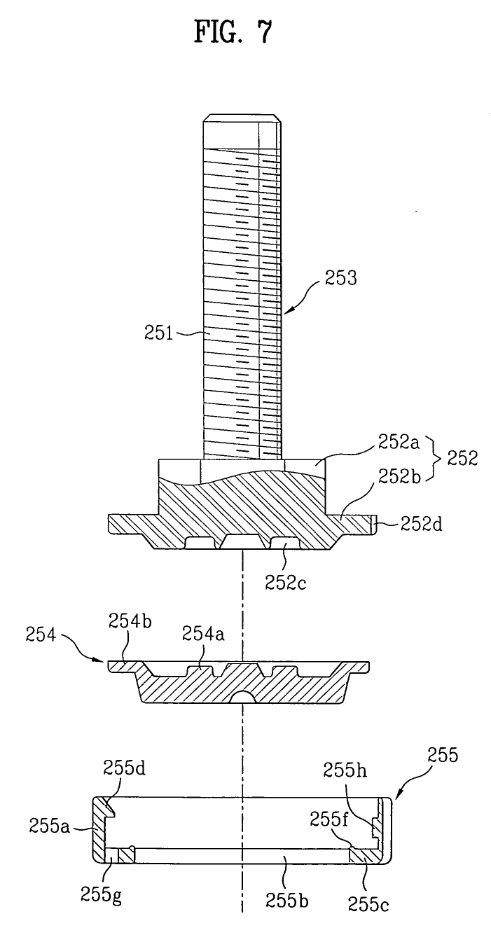

Referring to FIGS. 5 to 7, the leg assembly 250 includes a leg bolt 253 having a screw part 251 with a thread on an outside circumferential surface for fastening to a lower part of the stand body, and a bolt head 252 at a lower end of the screw part 251, a damping member 254 of a soft material having an upper surface in close contact with the bolt head 252 and a lower surface in contact with a floor where the stand stands thereon, and a holder 255 for holding the damping member 254 and the bolt head 252 together.

The bolt head 252 includes a polygonal upper head part 252a formed as one unit with the screw part 251 at a lower end thereof, and a circular lower head part 252b formed as one unit with, and under, the upper head part having a rotation prevention grooves 252c in an underside surface.

The upper head part 252a is polygonal for turning with a tool, such as spanner or wrench, or hand, and the lower head part 252b has a large diameter compared to the upper head part 252a.

The damping member 254, in close contact with an underside surface of the lower head part 252b of the bolt head 252, for damping vibration or impact transmitted through the leg assembly 250, includes an underside surface to be in contact with a floor where the washing machine stand is to be placed, a top surface having rotation prevention projections 254a for insertion in the rotation prevention grooves 252c respectively for prevention of relative rotation of the damping member with respect to the leg bolt 253, and a circular flange 254b at an upper circumference in close contact with an underside periphery of the lower head part 252b, and held by the holder.

The rotation prevention grooves 252 are in a number the same with the rotation prevention projections 254a. It is favorable that around four rotation prevention grooves are formed for prevention of rotation. The rotation prevention groove 252c in the lower head part may have a variety of forms, such as slots, or circular grooves. It is effective that the rotation prevention groove 252 is formed at a predetermined radial distance from an underside center of the lower head part 252b in view of rotation prevention of the damping member. Of course, it is evident from above description that the rotation prevention grooves are formed in the upper surface of the damping member, and the rotation prevention projection is formed on the underside surface of the lower heat part 252b.

Next, the holder 255 is substantially annular with passed through top and bottom, for pressing an upper surface of an edge of the lower head part 252b and an edge of the damping member 254, i.e., the underside surface of the flange from an upper side and a lower side respectively, and holding the lower head part 252b and the damping member 254, together, when the damping member 254 is fastened to the underside of the lower head part 252b by the holder 225, and the lower part of the damping member 254 is projected downward through the circular opening 210 formed in a lower part of the holder 255.

In more detail, the holder 255 includes an annular holder body 255a with passed through top and bottom for holding outside circumferences of the lower head part 252b and the damping member 254, a lower holding part 255c having an outside circumferential surface connected to an inside circumferential surface of a bottom end of the holder body, to support an underside surface of the flange 254b of the damping member, and an opening 255b in a central part for pass through of the lower part of the damping member, and an upper holding part 252b projected from an upper inside circumferential surface of the holder body toward a center, for holding an upper surface of an edge of the lower head part 252b.

The upper holding part includes a plurality of hooks 255d formed at regular intervals in a circumferential direction, for easy assembly of the leg assembly. It is preferable that a distance from an upper surface of the lower holding part 255c of the holder 255 to an underside surface of the hooks 255d has a dimension smaller than a sum of a thickness of the flange of the damping member 254 and a thickness of the edge of the lower head part 252b.

It is also preferable that the holder 255 has an annular projection 255f from a top end of opening of the lower holding part 255c for pressing an inner side of the edge of the underside of the flange of the damping member 254 and fastening the damping member more firmly. The projection may be a plurality of projections at regular intervals in a circumferential direction.

It is preferable that the holder 255 has a plurality of cut away openings 255g in parts of the lower holding part under the hooks for easy fitting of the holder 255, additionally. The cut away openings 255g enables easy fitting of the holder 255 because it is easy to wide open between parts where the hooks 255d are formed.

In addition to above, the lower head part 252b of the bolt head has at least one holder rotation prevention slot along a circumferential direction of an outside circumferential surface of the lower head part 252b, and the holder body 255a has a holder rotation prevention projection 255h from an inside circumferential surface of the holder body 255a for inserting in the holder rotation prevention slot 252d. It is preferable that the holder rotation prevention projections 255h are formed between the hooks 255d alternately when seen from above.

It is preferable that the holder 255 is a non-soft member, and the holder body has an outside circumferential surface chamfered into polygon, for easy holding, and turning of the holder 255 with a tool, such as spanner, or wrench, or with a hand.

Above structure enables that the stand 100 can be used for the drum type washing machine or the laundry dryer as required, because the stand 100 has the leg seating members 220 on an upper surface of each of corners of the stand body 200, with seating holes formed at different positions to correspond to leg positions of the drum type washing machine or the laundry dryer.

Moreover, the height adjustable leg assembly on the underside of the stand body 200 enables easy height adjustment to suit to a height of the user, as well as easy leveling. Moreover, since the holder 255 has a polygonal structure of a non-soft material, the leg assembly 250 prevents slipping when the leg assembly 250 is turned with a hand, and particularly, fitting or removal of the leg assembly is easy, and workability for height adjustment is improved because a tool, such as a spanner or a wrench, can be used.

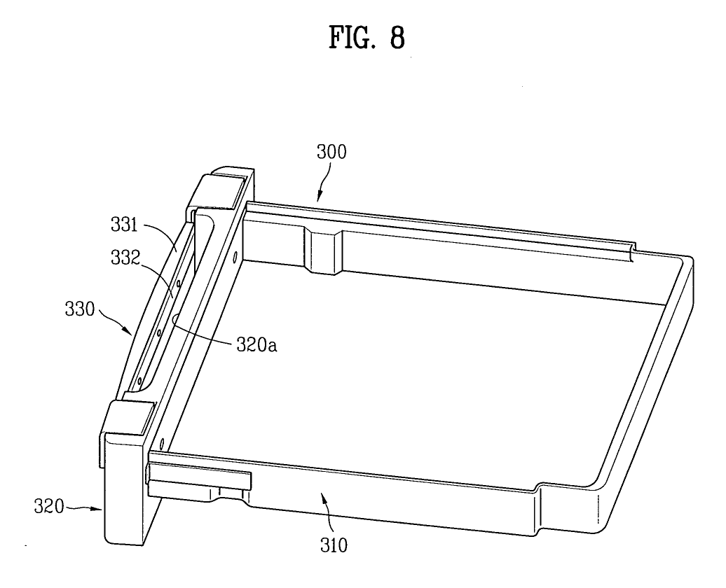

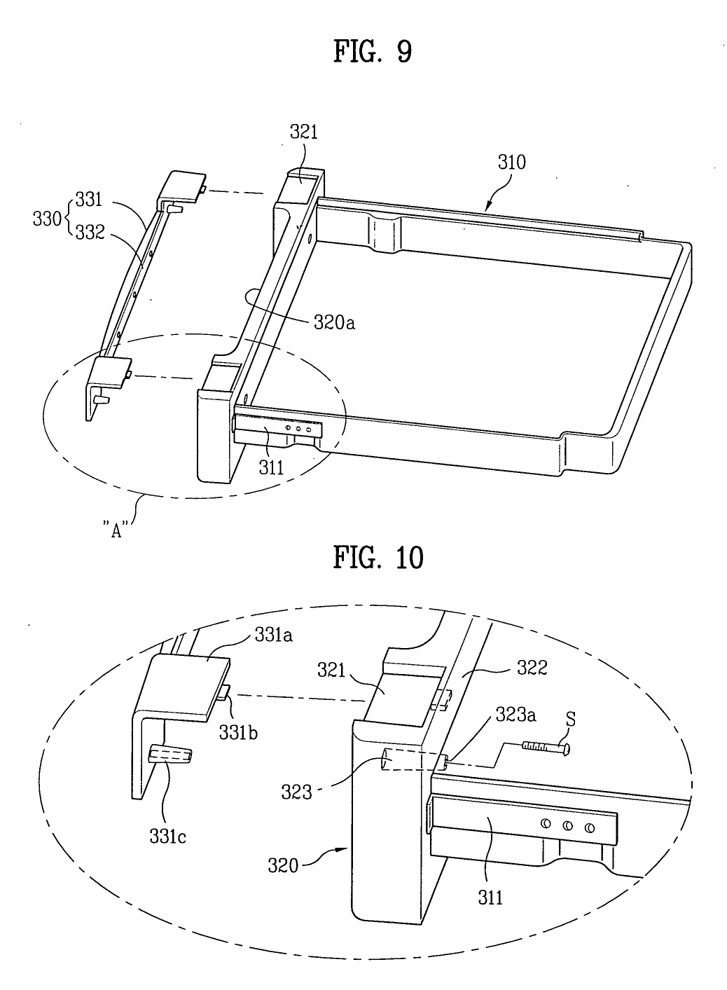

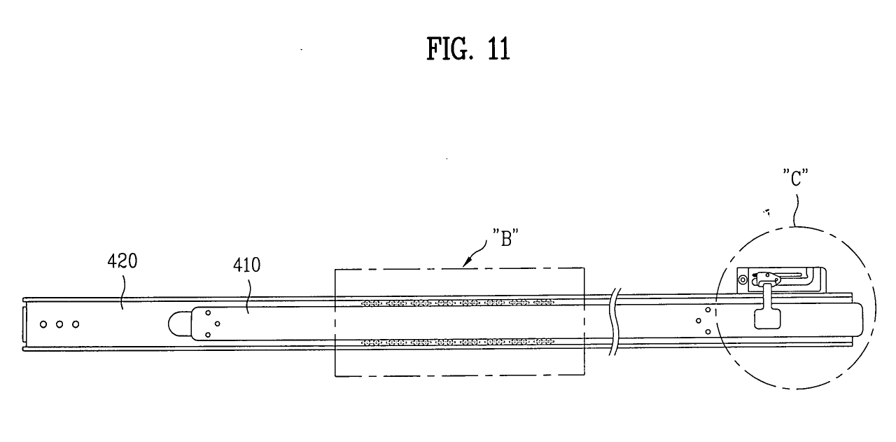

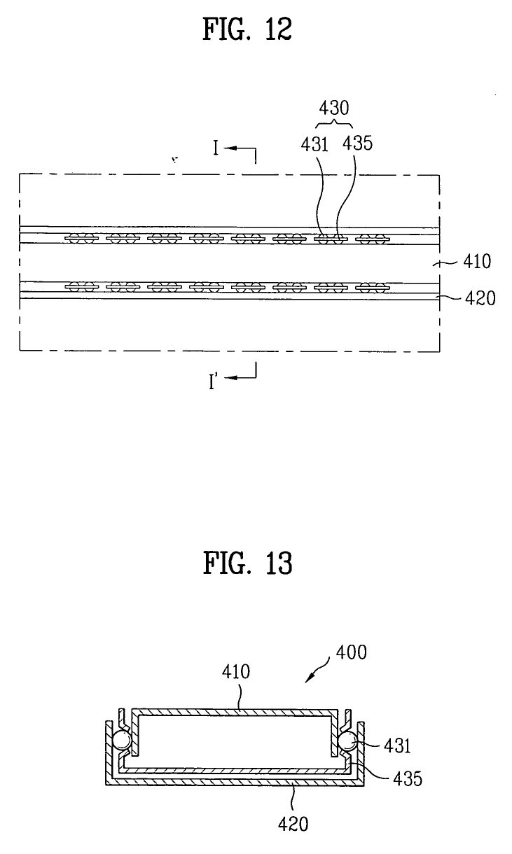

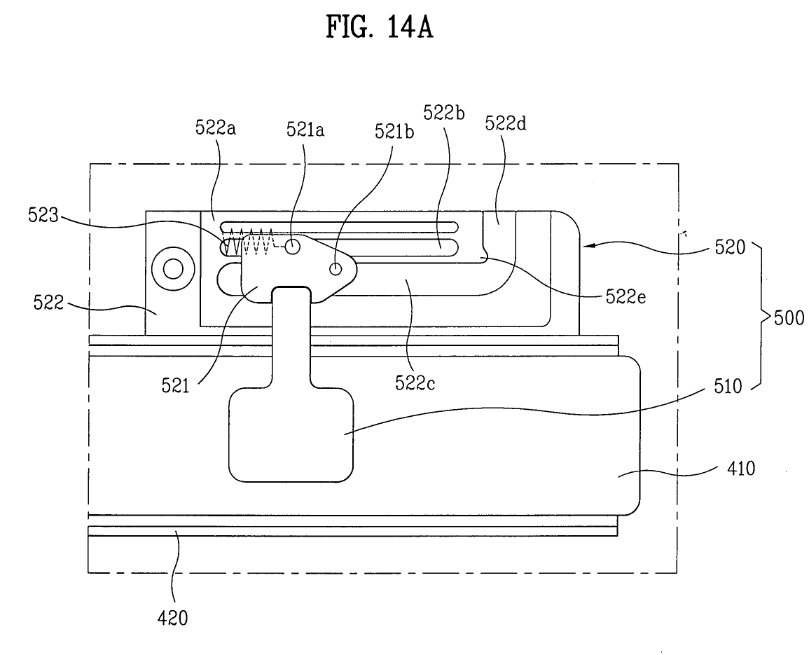

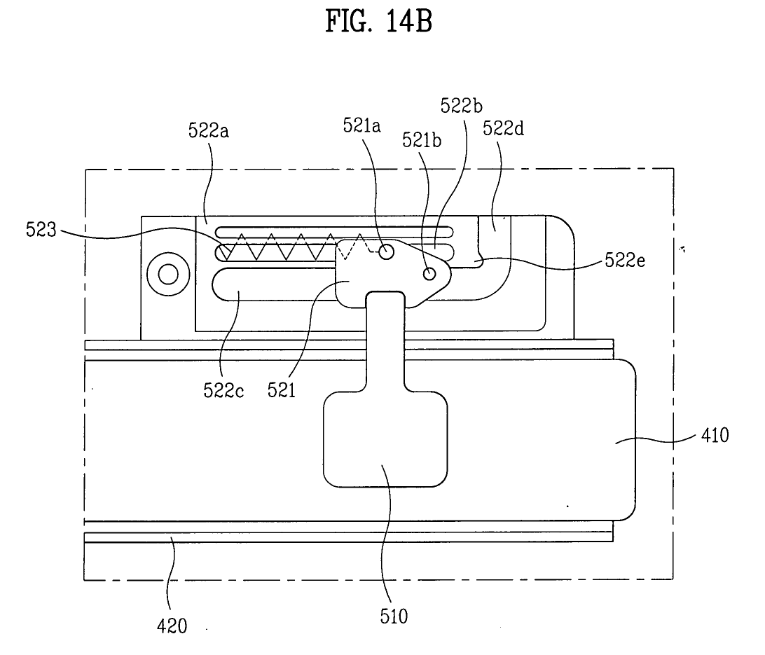

Next, referring to FIGS. 8˜10, the drawer 300 includes a drawer body 310 having a receiving space, a front cover 320, a front of the drawer body 310, for covering the opening of the stand body when pushed in, and a handle 330 on the front cover 320.

The front cover 320 covers the front of the stand body 200 where the opening 210 is formed entirely.

The handle 330 enables easy pulling out/pushing in of the drawer, and includes a front part 331 of the front of the handle, and a rear part 332 fastened to a rear of the front part 331 with screws.

The handle 330 has opposite ends projected to rear when seen from above to form a “⊂”, substantially. In more detail, the handle 330 has one pair of seating parts 331a at opposite sides of an upper surface of the front part 331 projected to a rear direction for being seated on opposite sides of the upper surface of the front cover 320, a fixing projection 331b projected backward from a rear end of each of the seating part 331a, and one pair of fastening projections 331c under the one pair of the seating part 331a, each having a thread in an inside circumference for fastening to the front cover. In correspondence to this, the front cover 320 has one pair of seating recesses 321 in an upper surface of opposite sides of the front cover 320 for seating the seating part 331a, a fixing hole 322 in a rear inside wall of each of the seating recesses 321 for inserting the fixing projection 331b, and pass through holes 323 in a front of the front cover 320 passed through a front surface and a rear surface of the front cover for inserting the fastening projections 331c and fastening with screws ‘S’.

It is preferable that the rear part 332 is formed of a material having a strength higher than a predetermined value for reinforcing entire strength of the handle 330.

For easy holding of the handle 330, there is a recess 320a of a predetermined depth in rear of the handle 330 in the front surface of the front cover 320.

In more detail, since the handle 330 forms a front exterior of the front cover 320, and a middle part of the front cover 320 positioned in rear of the handle 330 is recessed backward for easy holding, preventing the handle 330 from projecting toward front of the front cover 320 significantly, the washing machine stand 100 can have a secure and neat exterior while an overall volume of the stand 100 is not made large.

That is, if the recess is not formed in the middle part of the front cover 2b, it is required to for the handle 330 to project forward of the front cover 320 for forming a gap for holding the handle, to make an entire volume of the drawer 300, and to bump against other thing, a foot or a leg of the user, thereby causing damage to the handle or injury of the user.

Above structure enables rigid fastening of the handle 330 and the front cover 320 to each other. That is, by fastening the screws ‘S’ from rear of the front cover 320 in a state the seating parts 331a of the handle 330 are seated on the seating recessed 321 of the front cover with the fixing projections 331b inserted in the fixing holes 332 respectively, and the fastening projections 331c of the handle is inserted in the pass through holes in the front cover 320, the handle 330 is mounted to the front cover 320.

It is preferable that rear ends of the pass through holes 323, i.e., circumferences of entrances 323a where the screws ‘S’ are to be inserted are recessed forward, so as not to project the screws ‘S’ from the rear surface of the front cover.

Different from above structure, the handle 330 may be fastened to the front cover 320 with screws in a state the seating parts 331a of the handle are seated in the seating recesses 321, or the handle may be fastened to the front cover by forming hooks at required parts of the handle and by forming hook recesses in required parts of the front cover.

In the meantime, the stand body 200, and the drawer body 310 are provided with a guide device 400 for pushing in, or pulling out the drawer 300.

Referring to FIGS. 1113, the guide device 400 includes a supporting guide 410 of a bar or channel form mounted on opposite inside surfaces of the stand body 200 in a pulling out/pushing in direction of the drawer, a pulling out/pushing in guide 420 of a channel form with a “⊂” form of groove for inserting the supporting guide therein mounted on opposite outside walls of the drawer body 310 in the pulling out/pushing in direction of the drawer, and rolling means 430 for minimizing friction between the supporting guide 410 and the pulling out/pushing guide 420, to make the pulling out/pushing of the drawer smooth. Of course, forms of the supporting guide 410 and the pulling out/pushing in guide 420 may be opposite. That is, the supporting guide may have a channel form, while the pulling out/pushing in guide has a bar form.

The pulling out/pushing in guide 420 may be fastened to a drawer bracket 311 at a front end of opposite sides of the drawer body 310 with screws, or to the opposite sides of the drawer body directly.

The rolling means 430 includes rolling members 431 between the supporting guide 410 and the pulling out/pushing in guide 420, and a rolling member supporting part 435 for rotatably supporting the rolling members 431. The rolling member 431 may be a ball or a roller, and it is favorable that grease or lubricant is applied to the rolling member 431 for reducing friction during pulling out/pushing in of the drawer. The rolling member supporting part 435 may be fastened to the pulling out/pushing guide, or the supporting guide depending on a design condition.

In addition to above, the washing machine stand 100 includes a self-locking device 500 for automatic closing, and holding the drawer 300 if the drawer 300 is pushed in more than a certain depth of the stand body 200, and maintaining a state the drawer 300 is held unless an external force higher than a certain level is applied thereto.

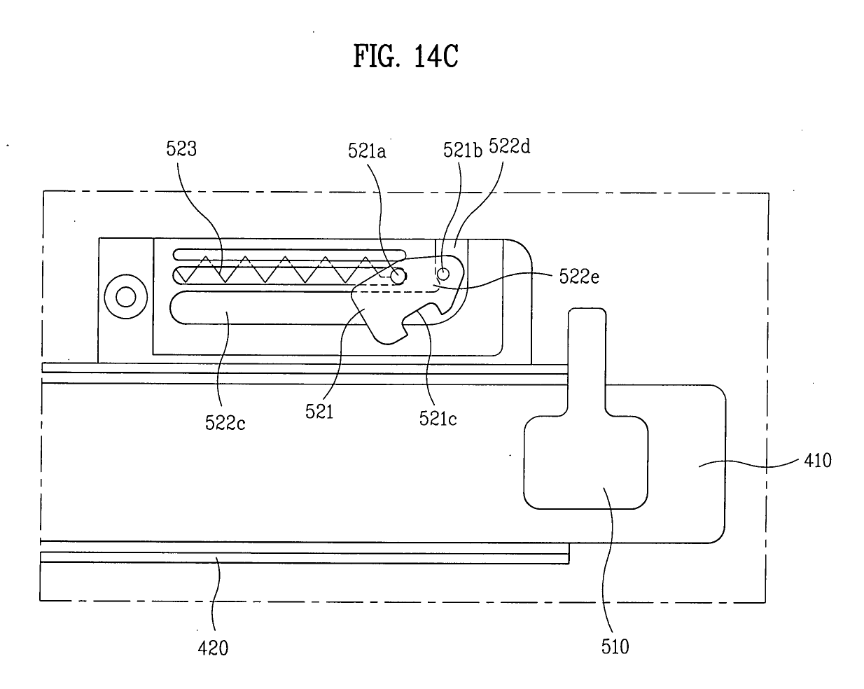

Referring to FIGS. 14A to 14C, the self-locking device 500 includes a holding member 510 fitted to the supporting guide 410, and a hook assembly 520 fitted to the pulling out/pushing in guide for engagement with the holding member 510 if the drawer 300 is pushed in the stand body 200 more than a certain depth, to close the drawer 300 automatically, and disengagement from the holding member 510 to open the drawer if the drawer 300 is pulled with an external force higher than a certain level applied for pulling out the drawer.

Though the holding member 510 is fitted to a rear portion of the supporting guide, such as a rear end of the supporting guide 410 or a position spaced a predetermined distance from the rear end of the supporting guide 410 in a front direction, the fitted position of the holding member 510 is not limited to this. The holding member 510 has a projection projected in a direction perpendicular to a direction of movement of the pulling out/pushing in guide 420 for engagement with the hook assembly 520.

Though the hook assembly 520 is fitted to a rear portion of the pulling out/pushing guide, such as a rear end of the pulling out/pushing in guide 420 or a position spaced a predetermined distance from the rear end of the pulling out/pushing in guide 420 in a front direction, the fitted position of the hook assembly 520 is not limited to this.

The hook assembly 520 includes a hook part 521 for engagement with the projection on the holding member 510 when the drawer 300 is pushed in the stand body 200 more than a certain depth, and disengagement from the holding member 510 when an external force higher than a certain level is applied thereto for pulling out the drawer 300, a hook guide part 522 for guiding movement of the hook part 521 in a state the hook part 521 is engaged with the holding member 510, and guiding the hook part 521 to disengage from the holding member 510 when the drawer 300 is pulled out more than a certain distance, and an elastic part connected between the hook part 521 and the hook guide part 522, for applying a restoring force to the hook part 521 to close the drawer 300 automatically if the hook part 521 is engaged with the holding member 510 following pushing in of the drawer 300 in the stand body 200 to make the hook part 521 to engage with the holding member 510.

The hook guide part 522 includes a guide body 522a fixed to the pulling out/pushing in guide 420, and guide slots 522b, 522c, and 522d in the guide body 522a for guiding movement of the hook part.

The guide slots includes a first guide slot 522b extended in the pulling out/pushing in direction of the drawer, a second guide slot 522c under the first guide slot 522b parallel to the first guide slot, and a third guide slot 522d vertically extended from a rear end of the second guide slot 602 toward the first guide slot 601. The rear end of the second guide slot 522c is extended more than a predetermined length longer than the rear end of the first guide slot 522b so that the third guide slot 522d and the first guide slot 522b do not cross each other.

The hook part 521 has a holding recess 521c or a hook. That is, the holding recess 521c of the hook part 521 has a “⊂” form in conformity with a form of the holding member 510, the form of the holding recess 521c is not limited to this.

The hook part 521 has a side surface fixed to a first pin 521a movable along the first guide slot 522b, and a second pin 521b movable along the second guide slot 522c or the third guide slot 522d, so that the hook part 521 rotates in a clockwise or anti-clockwise direction around the first pin 521a at the rear end of the first guide slot 522b when the hook part 521 is engaged with, or disengaged from, the holding member 510, respectively. The first pin 521a and the second pin 521b may be pins or has a rotatable structure, such as roller.

In addition to above, there is a projection from an inside corner where the second guide slot 522c and the third guide slot 522d meet, such that an entrance to the third guide slot has a form of a bottle neck. According to this, the hook part 521 rotates around the first pin 521a in a clockwise direction, or anti-clockwise direction, leading the second pin 521b to engage with or disengage from the projection 522e of the third guide slot, thereby self locking, or releasing the self locking of the drawer.

It is required that a radius of curvature of the projection 522e is designed to have an appropriate size, for preventing the engagement of the hook part 521 with the projection 522e from being disengaged easily by an external impact or the like which is not related to closure of the drawer from an opened state of the drawer 300, and for preventing to require an excessive force when the drawer 2 is closed.

In the meantime, it is preferable that the elastic part is a spring 523. If the spring 523 is a tension spring, the spring 523 has one end connected to the hook part, particularly, at a side of the first pin 521a, and the other end connected to the guide body, particularly, to a front end of the first guide slot 522b. Though not shown, if the spring is a compression spring, opposite to the case of the tension spring, the spring 523 has one end connected to a side of the first pin 521a, and the other end connected to a rear end of the first guide slot 522b.

Positions of the holding member 510 and the hook assembly 520 may be exchanged. That is, the hook assembly 520 may be fitted to the supporting guide 410, and the holding member 510 may be fitted to the pulling out/pushing in guide 420. The hook assembly and the holding member may be mounted on one side of the drawer, and on inside walls of the stand body so as not to interfere with the guide device.

A process for pulling out/pushing in the drawer with the self locking device will be described.

FIG. 14A illustrates a diagram of a self locking device in a state the drawer is closed fully, when the hook part 650 is engaged with the holding member, to be positioned at a front end side of the first guide slot 522b and the second guide slot 522c. That is, since the spring applies force to the hook part 521 having the holding member engaged therewith in a direction opposite to a direction of pulling out of the drawer, the drawer 300 is not slipped out of the stand body 200 even if the washing machine stand 100 is tilted, or the drawer is pulled forward with force lower than the restoring force of the spring. In other words, if it is intended to open the drawer in a state the drawer 2 is closed fully, it is required to pull the handle of the drawer with a force higher than a certain level.

FIG. 14B illustrates a diagram of a self locking device in an initial state when the drawer starts to open. When the user pulls the handle 330 of the drawer forward, the pulling out/pushing in guide 420 moves, to move the guide body 522a of the hook guide part forward, and the hook part 521, engaged with the holding member 510, makes relative movement to rear of the guide body 522a guided by the first guide slot 522b and the second guide slot 522c. In this instance, since the hook part 521 has a restoring force kept applied thereto from the spring, if the user releases the handle 330, the drawer 300 is closed fully by the spring, again.

If the user keeps pulling the handle 330 of the drawer forward in a state of FIG. 14B, the first pin 521a of the hook part 521 is engaged with the rear end of the first guide slot 522b, such that the hook part 521 can not make linear movement anymore, but can make rotating movement around the first pin 521a in an anti-clockwise direction. According to the rotating movement of the hook part 521, the second pin 521b of the hook part 521 passes a rear end of the second guide slot 522c, and moves into the third guide slot, and engages with the projection 522e at the entrance to the third guide slot 522d. In this state, the hook part 521 is held in a state the second pin 521b is engaged with the projection 522e by the force applied from the spring, and a reaction force of the projection 522e, while the holding member 510 and the hook part 521 are disengaged, such that the drawer 300 is pulled out in a front direction by the guide device 400, smoothly.

FIG. 14C illustrates a diagram of a state engagement by the self locking device 500 is disengaged.

Opposite to this, if the drawer 300 is pushed in for closing the drawer 300, the hook part 521 engaged with the projection at the third guide slot engages with the holding member 510 fitted to the supporting guide 410, rotates in a direction opposite to a direction when the drawer 300 is pulled out, i.e., in a clockwise direction, around the first pin 521a, such that the second pin moves to the rear end of the second guide hole 522c.

Starting from this time, the drawer is closed automatically by the restoring force of the spring, and held at a fixed force, even if the user applies no force.

Though the drum type washing machine and the laundry dryer are mostly illustrated as an object that can be supported by the stand, the object is not limited to above, it is evident that the object is not limited to above, but the object may be any general home appliance.

As has been described, the stand for a home appliance of the present invention has the following advantages.

First, the drawer which can be pull out/push in permits effective use of an inside space.

Second, the guide device permits smooth pull out/push in of the drawer.

Third, the self locking device permits automatic closure, and locking of the drawer when the drawer is pushed in the stand body more than a certain depth, and the locking is not released unless an external force higher than a certain level is applied thereto.

Fourth, the recess part for holding the handle and preventing projection of the handle to forward of the drawer permits to prevent increase of an overall volume of the washing machine stand, and bumping of the handle against an external thing, to damage the thing or give injury to the user.

Fifth, the leg seating members on the upper surface of the stand for enabling seating of the laundry dryer other than the washing machine permits the stand to use for the washing machine or the laundry dryer regardless of the leg positions.

Sixth, the height adjustable leg assemblies on an underside surface of the stand body permits adjustment of the washing machine stand suitable to a height of user, or leveling of the washing machine stand.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. (canceled)

2. A drawer for a stand supporting home appliances, the drawer comprising:
a drawer body having a receiving space formed therein,
a front cover that is a front of the drawer body for covering the opening of the stand body of the stand when the drawer body is pushed in, and
a handle provided to the front cover, wherein the handle includes one pair of seating parts projected backward from opposite sides of an upper surface of the handle, and
the front cover includes one pair of seating recesses in opposite sides of an upper surface of the front cover for seating the one pair of seating parts.

3. The drawer as claimed in claim 2, wherein the front cover has a recess formed in rear of the handle at a predetermined depth.

4. The drawer as claimed in claim 2, wherein the handle includes a front part that is a front of the handle, and a rear part in rear of the front part.

5. The drawer as claimed in claim 2, wherein the handle is fastened to the front cover with fastening projections each having an axial direction hole with a thread formed therein projected from a rear surface of the handle to backward, and pass through hole passed through a front and a rear surfaces of the front cover to insert the fastening projections therein, and fasten.

6. (canceled)

7. The drawer as claimed in claim 2, wherein the handle includes a fixing projection of a predetermined size projected backward from each of the seating parts, and the front cover includes a fixing hole in a rear wall of each of the seating recesses of the front cover for inserting the fixing projection.

8-15. (canceled)

16. A self locking device for automatic closure and holding a drawer if the drawer is pushed in a stand body more than a certain depth, and maintaining a holding state of the drawer unless an external force higher a certain level is not applied thereto, comprising:
a hook guide part for guiding movement of a hook part in a state the hook part is engaged with a holding member, wherein the hook guide part includes:
a first guide slot extended in the pulling out/pushing in direction of the drawer,
a second guide slot parallel to a first guide slot, having a rear end extended more than a predetermined length longer than a read end of the first guide slot.

17. The self locking device as claimed in claim 16, wherein the holding member is fitted to the supporting guide, the self locking device further including: a hook assembly fitted to the pulling out/pushing in guide for engagement with the holding member if the drawer is pushed in the stand body more than a certain depth, to close the drawer automatically, and disengaging from the holding member to open the drawer smoothly if the drawer is pulled out with an external force higher than a certain level applied for pulling out the drawer.

18. The self locking device as claimed in claim 17, wherein the holding member is fitted to a rear portion of the supporting guide, and the hook assembly is fitted to a rear portion of the pulling out/pushing in guide to align with the holding member when the drawer is closed fully.

19. The self locking device as claimed in claim 17, wherein the hook assembly includes;
a hook part for engaging with the holding member when the drawer is pushed in the stand body more than a certain depth, and disengaging from the holding member when an external force higher than a certain level is applied thereto for pulling out the drawer,
the hook guide part for guiding movement of the hook part in a state the hook part is engaged with the holding member, and guiding the hook part to disengage from the holding member when the drawer is pulled out more than a certain distance, and
an elastic part connected between the hook part and the hook guide part, for applying a restoring force to the hook part to close the drawer automatically if the hook part is engaged with the holding member following pushing in of the drawer in the stand body to make the hook part to engage with the holding member.

20. The self locking device as claimed in claim 19, wherein the hook guide part includes;
a third guide slot vertically extended from the rear end of the second guide slot toward the first guide slot, and
the hook part includes;
a first pin movable along the first guide slot, and
a second pin movable along the second guide slot or the third guide slot.

21. The self locking device as claimed in claim 19, wherein the hook guide part further includes a projection from an inside corner where the second guide slot and the third guide slot meet, for engaging of the hook part therewith when the drawer is pulled out more than a certain distance to disengage the hook part from the holding member.

22. The self locking device as claimed in claim 19, wherein the elastic part includes a spring having one end connected to a first pin of the hook part, and the other end connected to a front end of the first guide slot.

23-26. (canceled)

27. A height adjustable leg assembly, each leg assembly provided to an underside surface of the stand body, comprising
a damping member of a soft material having an upper surface in close contact with a bolt head and a lower surface in contact with a floor where the stand stands thereon, and
a holder for holding the damping member and the bolt head together.

28. The leg assembly as claimed in claim 27, wherein the leg assembly includes a leg bolt having a screw part with a thread on an outside circumferential surface for fastening to a lower part of the stand body, and a bolt head at a lower end of the screw part.

29. The leg assembly as claimed in claim 28, wherein the bolt head includes
a polygonal upper head part formed as one unit with, and at a lower end of, the screw part, and
a circular lower head part formed as one unit with, and under, the upper head part.

30. The leg assembly as claimed in claim 29, wherein the damping member is fastened to the lower head part for preventing relative rotation with respect to the leg bolt.

31. The leg assembly as claimed in claim 28, wherein the holder is substantially annular, for pressing an upper surface of an edge of the lower head part and an underside surface of an edge of the damping member from an upper side and a lower side respectively, and holding the lower head part and the damping member together, when the lower part of the damping member is projected downward through the passed through lower part.

32. The leg assembly as claimed in claim 28, wherein the holder includes;
an annular holder body for holding outside circumferences of the lower head part and the damping member,
a lower holding part having an outside circumferential surface connected to an inside circumferential surface of a bottom end of the holder body, to support an underside surface of the damping member, and
an opening in a central part for pass through of the lower part of the damping member, and
an upper holding part projected from an upper inside circumferential surface of the holder body toward a center, for holding an upper surface of an edge of the lower head part, having a distance from an upper surface of the lower holding part to an underside surface smaller than a sum of a thickness of the edge of the damping member and a thickness of the edge of the lower head part.

33. The leg assembly as claimed in claim 32, wherein the upper holding part includes a plurality of hooks at regular intervals in a circumferential direction.

34. The leg assembly as claimed in claim 28, wherein a lower holding part includes a plurality of cut away openings under the hooks respectively.

35. The leg assembly as claimed in claim 28, wherein the holder and the leg bolt are formed not to make relative rotation.

36. The leg assembly as claimed in claim 35, wherein the holder includes holder rotation prevention projections in an inside surface thereof, and the bolt head includes holder rotation prevention grooves on an outside surface thereof for inserting the holder rotation prevention projections therein.

37. The leg assembly as claimed in claim 35, wherein the holder is formed of non-soft material, and has a polygonal outside circumferential surface.

38. (canceled)
